(19) United States
(12) Patent Application Publication
(10) Pub. No.: US 2008/0011573 A1
(43) Pub. Date: Jan. 17, 2008

(54) Synchronizing device

(76) Inventors: Christoph Wefers, Baltmannsweiler (DE); Dittmar Wieland, Oppenweiler (DE); Joachim Zinsser, Hochdorf (DE)

Correspondence Address: KLAUS J. BACH, 4407 TWIN OAKS DRIVE, MURRYSVILLE, PA, 15668, US

(21) Appl. No.: 11/486,431

(22) Filed: Jul. 13, 2006

(51) Int. Cl. F16D 23/06

(52) U.S. Cl. 192/53.361

(57) ABSTRACT

In a synchronizing device with a synchronizing body, a sliding sleeve for coupling the sliding body to a gear wheel, two synchronizing rings for rotational speed matching between the synchronizing body and the gear wheels, and a pivotable balancing lever having opposite arm extending into support openings in the synchronizing rings, the balancing levers are pivotable about a central axis so as to permit limited rotation of the synchronizing rings relative to the synchronizing body.

### BACKGROUND OF THE INVENTION

The invention relates to a synchronizing device with a synchronizing body, a shift ring for coupling the synchronizing body to a gear wheel and synchronization ring for adjusting the speed of the components to be coupled.

A synchronizing device with a synchronizing body, a shift ring, two synchronizing rings, a pressure piece, a compression spring, a catch body and a pivotably movable balancing lever is already known from DT 24 31 324 B1. The balancing lever is engaged at each of its two opposite ends in the peripheral direction with the respective synchronizing ring. The balancing lever consequently acts as a balance beam between the two synchronizing rings and is intended to prevent hard impact of stops of the friction rings when torsional vibrations of the synchronizing device occur.

Leaf springs arranged between the synchronizing body and the synchronizing ring are also known from DT 26 28 039 B1.

Springs forming torsional stops for synchronizing rings are known from DE 32 08 979 A1.

It is an object of the invention to provide a compact, cost-effective synchronizing device which prevents clattering and rattling noises as a result of drive train vibrations in the transmission.

### SUMMARY OF THE INVENTION

In a synchronizing device with a synchronizing body, a sliding sleeve for coupling the synchronizing body to a gear, two synchronizing rings for rotational speed matching between the synchronizing body and the gear wheels, and a pivotable balancing lever having opposite arm extending into support openings in the synchronizing rings the balancing levers are pivotable about a central axis so as to permit limited rotation of the synchronizing rings relative to the synchronizing body.

Drive train vibrations occur especially during the
changing of gears
engaging of the clutch
disengaging of the clutch
starting the drive engine
stopping the drive engine
unintentional stopping—stalling—of the drive engine
engine idling
driving at low rpm and
accelerating at low rpm.

In particular supercharged and/or diesel engines give rise to drive train noises as these engines experience relatively large rotational vibrations.

According to the invention, a balancing lever is advantageously arranged pivotably between the two synchronizing rings. The functionally necessary twistability of the two synchronizing rings in relation to the synchronizing body is thus maintained. When angular accelerations of the two synchronizing rings occur owing to drive train vibrations, however, both synchronizing rings are supported in the same peripheral direction by the balancing lever which is embodied in principle as a balance beam. The two synchronizing rings are consequently prevented from being accelerated in the peripheral direction and striking hard against a stop necessitated by the synchronizing principle. As the balancing lever consequently limits the rotary mobility at least in the case of angular acceleration of the synchronizing sleeves in the same direction, the balancing lever can also, in a particularly advantageous embodiment, be designed in such a way that it limits the rotary movement of the two synchronizing sleeves in opposite directions of rotation. In this case, it is possible to omit a further stop for the synchronizing sleeves in relation to the synchronizing body.

However, the combination of balancing lever and additional stop presents itself in particular for the use in connection with synchronizing devices which are already proven.

Owing to the common arrangement of the balancing lever and the pressure piece in one region, the construction space requirement for these two units is very small.

In an especially advantageous way, the pressure piece and the balancing lever can even be designed as a preassembled subassembly. The safety against loss or assembly safety can be improved still further by the compression spring and the catch body also being assigned captively to this subassembly.

As there will inevitably be friction and high bending load of the balancing lever, this can especially advantageously be made from non-metallic materials with/without reinforcement or from metal materials.

In a particularly compact, assembly-friendly and cost-effective way, the synchronizing device can be made in one piece with the balancing lever and has rounded lateral surfaces which allow pivoting of the pressure piece.

The invention will become more readily apparent from the following description of a preferred embodiment with reference to accompanying drawings.

### BRIEF DESCRIPTION OF THE DRAWINGS

FIG. 1 shows a detail of a synchronizing device which comprises a synchronizing sleeve, a synchronizing body and a pressure piece with a balancing lever;

FIG. 2 shows a further detailed view in a section which runs through an axis of rotation of a gear shaft and a central axis of the pressure piece from FIG. 1;

FIG. 3 shows the pressure piece from FIG. 1;

FIG. 4 shows the said pressure piece in a sectional view taken along its central axis, and

FIG. 5 shows a particular embodiment of the pressure piece, wherein the pressure piece and the balancing lever consist of one piece, so that two functions are combined in one single component.

### DESCRIPTION OF A PREFERRED EMBODIMENT

Two synchronizing rings 2, 3, a synchronizing body 1, a pressure piece 4 and a balancing lever 5 according to the detail shown in FIG. 1 find application in a synchronizing device. This synchronizing device can be embodied in particular as a single-cone synchronizing device according to the Borg-Warner system as is explained for example in “G. Lechner, Fahrzeuggetriebe [Vehicle Transmissions], Springer-Verlag Berlin Heidelberg, 1994, page 238 to page 241”. The synchronizing device described here can also find application in a multiple-synchronizing device. This may be a double or triple synchronizing device, for example. The content of the publication mentioned above is to be regarded as included for explanation of the single-cone synchronizing device according to the Borg-Warner system which is well known to the experts.

FIG. 1 shows the detail in a development which is effected peripherally around an axis of rotation 6 of a gear shaft (not illustrated here). The axis of rotation 6 coincides with the axis of rotation 6 of the synchronizing device, the two synchronizing rings 2, 3 and the synchronizing body 1.

The synchronizing body 1 is arranged coaxially with and in a rotationally fixed manner in relation to the gear shaft and has peripherally a number of recesses 7 which extend parallel to the axis of rotation 6. Two stop noses 8, 9 of the synchronizing rings 2, 3 abut the two sides in each of the recesses 7. Both synchronizing rings 2, 3 are thus limitedly rotationally movable in relation to the synchronizing body 1 in both peripheral directions 10, 11 by a torsional play 12 or 13.

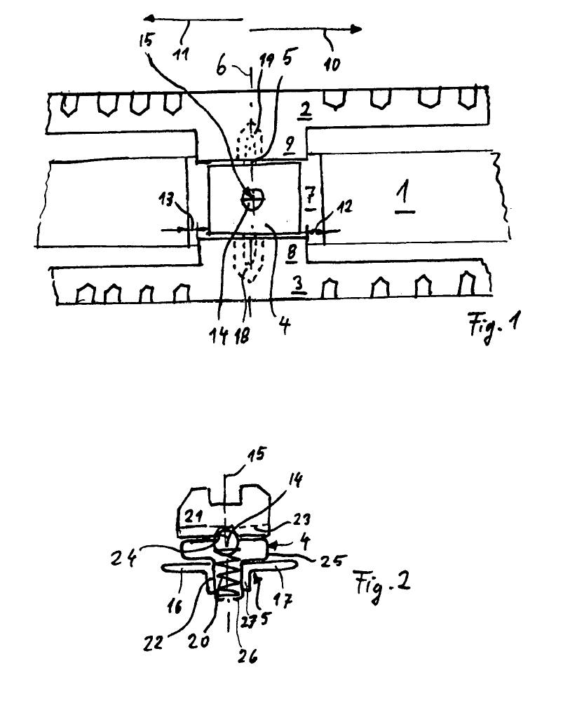

The pressure piece 4 is located between the two stop noses 8, 9. This pressure piece 4 has a catch ball 14 which is located on a central axis 15 of the pressure piece which lies at right angles to the said axis of rotation 6 and can be seen more clearly in FIG. 2. The balancing lever 5 is arranged pivotably about this central axis 15. The two arms 16, 17 of the balancing lever 5 extend into bores 18, 19 of the respective stop noses 8, 9. The two bores 18, 19 are aligned with one another and are parallel to the the axis of rotation 6 of the gear shaft.

FIG. 2 shows a more detailed view of a section in a plane which extends between the axis of rotation 6 of the transmission shaft and a central axis 15 of the pressure piece 4 from FIG. 1. In this connection, it can be seen that the pressure piece 4 together with the catch ball 14, a helical compression spring 20 for pressing the catch ball 14 against a sliding sleeve 21, a spring guide cylinder 22 and the balancing lever 5 are combined into an assembly-friendly, compact component.

The sliding sleeve 21 is in the usual way displaceable along the axis of rotation 6 of the transmission shaft in order to couple one of two gearwheels to the transmission shaft with their rotational speeds matched. In this connection, the sliding sleeve 21 is provided on the inside with an internal toothing 23 and in the region of the catch ball 14 a peripheral groove 24. This peripheral groove 24 lies axially centrally in the sliding sleeve 21 in relation to the axis of rotation 6, so that the catch ball 14 holds the non-actuated sliding sleeve 21 in a neutral position. On axial displacement of the sliding sleeve 21 in one of the two possible opposite directions, the pressure piece 4 takes the synchronizing ring 3 or 2 adjoining the stop nose 8 or 9 with it.

In this connection, it can be seen that the basic body of the pressure piece 4 is a shaped part which radially externally is a cuboid 25 in which the catch ball 14 is located centrally, the spring guide cylinder 22 extending co-axially with the central axis 15 adjoining the cuboid 25 radially internally. The helical compression spring 20 is located in this spring guide cylinder 22 and is supported radially outwardly on the catch ball 14. Radially inwardly, the helical compression spring 20 is supported on an annular collar 26 which extends in the direction of the central axis 15 from the radially inner end of the spring guide cylinder 22.

On the outside, an injection-molded plastic part is mounted on the cylinder 22, such that it is disposed adjacent to the cuboid 25. This injection-molded plastic part consists essentially of a sleeve 27 and the two arms 16, 17 which extend at the outer end diametrally from the sleeve 27 and away from one another and together form the balancing lever 5.

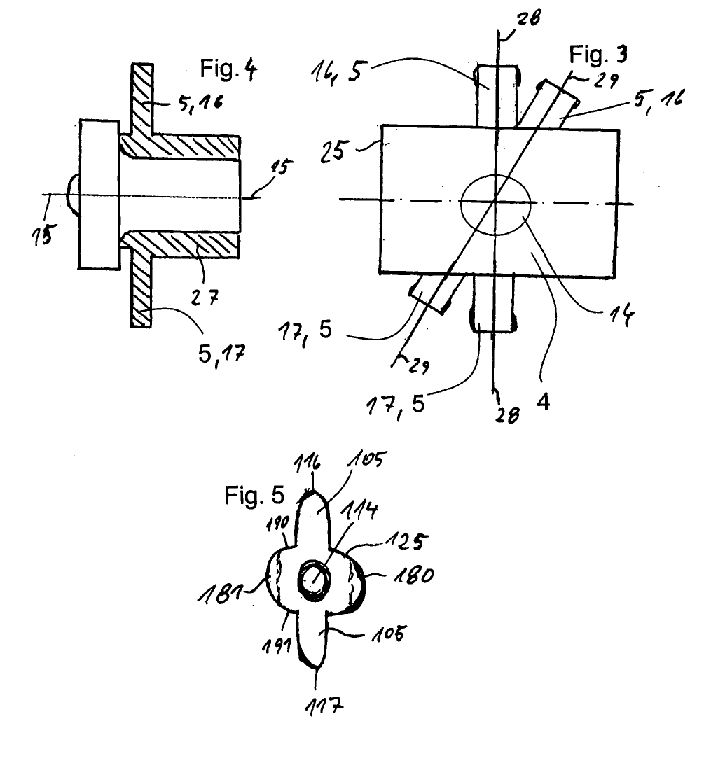

FIG. 3 shows the pressure piece 4 from FIG. 1 alone. The balancing lever 5 occupies a zero position 28 when virtually the same angular acceleration acts on both synchronizing rings 8, 9. In this zero position 28, the balancing lever 5 is aligned parallel to the said axis of rotation 6. The balancing lever occupies the synchronizing position 29 likewise illustrated in the same FIG. 3 during the synchronizing operation. After the internal toothing of the sliding sleeve 21 has made a positive connection to a toothing of the gearwheel, the zero position 28 is occupied again. In this connection, the balancing lever can occupy many synchronizing positions, of which only the one synchronizing position 29 is illustrated in the drawing.

The balancing lever 5 may occupy any number of positions between the zero position 28 and a synchronizing position 29 depending on the synchronizing phase. In this connection, the synchronizing device is dimensioned in such a way that the balancing lever 5 does not press the synchronizing rings against the counter friction surfaces in the zero position 28, that is with maximum axial deflection, so that pre-synchronization does not take place either.

FIG. 4 shows the pressure piece 4 with the injection-molded plastic part in a partly sectional view, the section running through the central axis 15 and only the balancing lever being illustrated in section.

FIG. 5 shows in a further embodiment of the synchronizing device a one-piece pressure piece in which a receiver 125 of the catch ball 114 or of a ball-head bolt and the balancing lever 105 are made as a one-piece part. This one-piece part can be made
both from non-metallic material, for example as an injection-molded plastic part
and from metal material, for example as a shaped sheet-metal part.

As the receiver 125 of the catch ball 114 or of the ball-head bolt consequently pivots with the balancing lever 105, this part is oval or alternatively circular in shape. That is, the receiver 125 or the pressure piece is made in one piece with the balancing lever and has rounded lateral surfaces 180, 181. In this connection, the contact surface for axially displacing the synchronizing ring can be both one of the end regions 116, 117 of the arms and one of the regions 190, 191 of the receiver 125 which lie diametrically in relation to one another and from which the arms extend.

In the synchronizing device according to FIG. 4, both a clearance fit and light pressing or a transition fit can be provided between the sleeve 27 and the outer surface of the spring guide cylinder 22. A clearance protects the sleeve 27 and the spring guide cylinder 22 against material stresses. Light pressing brings about additional friction, owing to the pre-stress, which damps the rattling of the synchronizing rings 8, 9 additionally. The selection of the fit is consequently dependent on the material selection. The sleeve 27 with the balancing lever 5 can in particular also be made from a polyamide with a glass fiber content of approximately 30%, for example. This material has particularly high wear resistance and high toughness. Other—in particular higher—contents of fiber reinforcement are conceivable. Other fiber materials are also conceivable for increasing the wear resistance. In particular, highly wear-resistant carbon fibers and Kevlar fibers are also possible. In particular plastics which have a temperature stability in the range of the permissible gear oil temperature which arises present themselves for the sleeve and the balancing lever. As far as the thermal loading of the plastic is concerned, it is to be taken into account that a reduction in friction is brought about in the transmission by the gear oil. Both thermoplastics and duroplastics can find application as plastics.

In FIG. 1, bores for receiving the balancing lever 5 in stop noses are illustrated. These bores do not have to be aligned but can also lie in two planes. Instead of the bores, other cutouts or even projections on the synchronizing rings, on which the arms of the balancing lever are supported, are conceivable. The end of the balancing lever is to be supported in the synchronizing ring in such a way that on shifting of the synchronizing ring both, the end of the balancing lever as well as the balancing lever are freely movable without force, the former relative to the synchronization ring and the latter about its axis of rotation.

Instead of the catch ball, other spring-force-loaded bodies can find application, such as for example the ball-head bolt according to “G. Lechner, Fahrzeuggetriebe, Springer-Verlag Berlin Heidelberg, 1994, page 239”.

A synchronizing device can have a number of pressure pieces. In this connection, only one or two or more, in particular all, of the pressure pieces may be provided with a balancing lever.

The embodiments described are only examples. A combination of the features described for different embodiments is likewise possible. Further features, in particular features not described, of the device parts belonging to the invention can be inferred from the geometries of the device parts illustrated in the drawings.

What is claimed is:

1. A synchronizing device comprising a synchronizing body (1), a sliding sleeve (21) for coupling the synchronizing body (1) to a gearwheel, two synchronizing rings (2, 3) for rotational speed matching between the synchronizing body (1) and the gearwheel, a pressure piece (4) and a compression spring (20) which presses a catch body (14) of the pressure piece (4) against the sliding sleeve (21), and a pivotably supported balancing lever (5) having opposite arms which are engaged in the peripheral direction (10 or 11) by the respective synchronizing rings (2, 3), said balancing lever (5) being pivotable about the central axis (15) of the compression spring (20) or of the catch body (14).

2. A synchronizing device according to claim 1, wherein the pressure piece (4) is a shaped sheet-metal part which forms an assembly unit captively accommodating the compression spring (20) and the catch body (14).

3. Synchronizing device according to claim 2, wherein the shaped sheet-metal part forms a spring guide cylinder (22) which is aligned in an engagement direction of the catch body (14), the balancing lever (5) being mounted pivotably on the spring guide cylinder (22).

4. Synchronizing device according to claim 3, wherein the catch body (14) is mounted on the spring guide cylinder (22) of the shaped sheet-metal part with pre-stress.

5. A synchronizing device according to claim 1, wherein the balancing lever (5) has a fiber-reinforced plastic region.

6. A synchronizing device according to claim 1, wherein the balancing lever (5) includes arms (16, 17) which are received in recesses (18, 19) formed in stop noses (8, 9) of the synchronizing rings (2, 3), the stop noses being received in grooves (7) of the synchronizing body (1), so that rotational movement of both synchronizing rings (2, 3) is limited in relation to the synchronizing body (1) in both peripheral directions (10, 11).

7. A synchronizing device according to claim 1, wherein the balancing lever (5) forms the peripheral stop for the synchronizing rings.

8. A synchronizing device according to claim 1, wherein the pressure piece (receiver 125) is made in one piece with the balancing lever (5) and has rounded lateral surfaces (180, 181) which allow pivoting of the pressure piece (receiver 125).
